(19) United States
(12) Patent Application Publication
(10) Pub. No.: US 2001/0034754 A1
(43) Pub. Date: Oct. 25, 2001

(54) Device, system and method for providing web browser access and control of devices on customer premise gateways

(76) Inventors: Amgad Mazen Elwahab, Reno, NV (US); Michael Allan Pelster, Reno, NV (US); Todd Bedros Smith, Reno, NV (US)

Correspondence Address: David A. Blumenthal, Foley & Lardner, Suite 3500, 2029 Century Park East, Los Angeles, CA, 90067-3021, US

(21) Appl. No.: 09/759,861

(22) Filed: Jan. 12, 2001

Related U.S. Application Data
(60) Provisional application No. 60/190,229, filed on Mar. 17, 2000.

(51) Int. Cl. G06F 15/16

(52) U.S. Cl. 709/201

(57) ABSTRACT

A customer premises gateway (CPG) for providing access and control of one or more devices located at a customer premise and coupled to the CPG through one or more physical interfaces is disclosed. The CPG comprises one or more processors in communication with each other. The one or more processors are programmed for associating an application programming interface (API) specific to a particular device with an Internetworking protocol, Transport protocol, software driver, and hardware driver. The processors are also programmed for querying a particular device and retrieving API specification information from the device using the API specific to the device, and generating a Markup-Language-type page for the device in accordance with the API specification information for the device for displaying accessible or controllable parameters of the device. The CPG also includes memory for storing the API specification information corresponding to the one or more devices. A Markup-Language-type Web browser is couplable to the CPG through a broadband communication link for viewing the Markup-Language-type pages and controlling and monitoring the devices.

### CROSS-REFERENCE TO RELATED APPLICATIONS

Embodiments of the present invention claim priority from U.S. provisional patent application Ser. No. 60/190,229 entitled “System for Providing Web Browser Access and Control of Devices on Customer Premises Gateway,” filed Mar. 17, 2000, the contents of which are incorporated herein by reference for all purposes.

### BACKGROUND OF THE INVENTION

1. Field of the Invention

The invention relates to a Markup-Language-type content server used in conjunction with a customer premise gateway that allows, via Markup-Language-type pages (e.g., HTML, XML, and the like), remote access and control of smart devices, appliances, personal computers, and other devices and systems connected at a customer premise via different communication means and protocols.

2. Description of Related Art

A number of systems have been proposed for automated appliance control whereby communication with the controlled devices is confined within a customer premise (e.g., a residential or commercial building) and is implemented via a wireless network of radio frequency transmitter/receiver devices and repeaters, or via a signal carrying bus. Two such systems are disclosed in U.S. Pat. Nos. 5,838,226 and 5,815,086. Such systems are disadvantageous in that they do not allow remote access through networks such as the Internet, and are limited to a particular wireless communication link. Furthermore, these systems do not allow the seamless integration and control of smart devices.

Systems have also been proposed which allow automation of customer premise devices such as appliances, a lighting system, a home security system and an environment control device (i.e., heating, ventilation and air conditioning (HVAC)) from a remote location, as well as within the home or office. One such system is disclosed in U.S. Pat. No. 5,086,385. The system comprises a central processor which is connected to the various devices and subsystems via a data bus. The system uses a high resolution graphics display and associated touch screen interface with other input devices such as a voice recognition system and telephone to allow the input of user commands. The system can be connected to an external network for operation from a remote location via an Ethernet link. Devices that use different protocols such as RS-232 can be connected to the system via a converter. A device can also be connected to the data bus through a converter to various home automation buses such as the consumer electronic bus standard (CEBus), the Smart House standard bus, LONWORKS® or X10. The above system is disadvantageous in that external communication with remote devices occurs through the Ethernet, and thus is applicable to Intranet applications, but not Internet applications. The above system is also disadvantageous because it does not allow broadband access such as digital subscriber line (DSL), cable, satellite feeds, and the like. Furthermore, these systems do not allow the seamless integration and control of smart devices.

U.S. Pat. No. 5,880,677, on the other hand, discloses a system for monitoring electrical consumption by devices from a remote location using a laptop and telephone line connection to the customer premise. A control unit is provided on the customer premise to integrate a home computer, the Internet, and the devices to be controlled. A user screen can be provided to facilitate the switching of devices on and off. The above system is disadvantageous in that it uses an application specific interface provided by specialized software provided on the laptop or computer. Thus, a user cannot gain access and control devices and appliances at a customer premise without a computer having the specific application software loaded thereon. In general, the above-described systems are disadvantageous in that they are limited to specific physical interfaces and protocols. This invention is also limited to a specific smart device (the electric meter) and does not encompass a methodology for managing and facilitating the integration of various the smart devices that may exist in a residential or commercial environment. The above-described system also lacks the capability to seamlessly integrate smart residential devices for management and control purposes.

### SUMMARY OF THE DISCLOSURE

It is an advantage of embodiments of the present invention to provide a device, system and method for centralized Markup-Language-type enabled (including XML enabled) web browser access and control of smart devices, appliances and systems such as HVAC, lighting and security systems on the customer premise. The system and method may be used to access any smart device connected to any physical interface using any communication protocol recognized by the system.

It is a further advantage of embodiments of the present invention to provide a device, system and method for centralized Markup-Language-type enabled (including XML enabled) web browser access and control of smart devices, appliances and systems such as HVAC, lighting and security systems on the customer premise in which an initial access Markup-Language-type page is accessible from local or remote locations from which the user can establish network access using essentially any computer, laptop or hand-held computing device. In other words, the user is not limited to local or remote access to the smart devices via a particular computer on which a specific appliance automation program is installed.

It is a further advantage of embodiments of the present invention to provide a device, system and method for centralized Markup-Language-type enabled (including XML enabled) web browser access and control of smart devices, appliances and systems such as HVAC, lighting and security systems on the customer premise that can multiplex high bandwidth data into the customer premise over a plurality of communication media, including broadband communications. Accordingly, visibility of all devices controlled within the customer premise is available from the same point. Furthermore, because the present invention can receive broadband communications, there is sufficient bandwidth to handle multiple simultaneous accesses to the system.

In accordance with one aspect of the present invention, a customer premise gateway (CPG) includes a Markup-Language-type content server, a SDIP (Smart Device Interface Publisher) for publishing smart devices APIs (Application Program Interfaces) and other smart device specifications such as the Internetworking protocol used (e.g., a particular device may use the IP or CEBus Internetworking protocol to deliver its API load), software drivers (which, for a number of protocols, encompasses a transport protocol such as TCP (Transport Control Protocol)), and a physical interface for each of a plurality of smart devices. The server maintains a Markup-Language-type page having icons for the devices which are produced by the SDIP after a new smart device API specification has been loaded into the SDIP (i.e., stored into persistent storage) using an SDIP API specification loading engine (parser). It should be noted that the API specification is a set of variables that identify the key fields being passed back and forth. A user would be able to navigate through the icons to manage and control smart devices represented by those icons.

In accordance with another aspect of the present invention, the devices at the customer premise are connected using different communication media and protocols. The CPG processes device management messages to determine an appropriate API (Application Program Interface) to be generated for a particular smart device, and transmits commands for devices using the correct protocol therefor.

In accordance with still yet another aspect of the present invention, an initial access Markup-Language-type page is generated by the SDIP and updated whenever a new device API (Application Program Interface) specification is loaded into the SDIP. Separate Markup-Language-type pages for different devices are accessed by navigating the initial access page. Those pages are also produced by the SDIP as a result of loading the smart device API specification into the SDIP.

In accordance with another aspect of the present invention, Markup-Language-type pages are provided with graphics indicating each of the different communication media used at a customer premise. Thus, the icon for each device indicates the physical medium used for that device using particular physical medium graphical notations, such as Ethernet, Home Phone line Networking Alliance (HPNA or HomePNA), and the like.

In accordance with another aspect of the present invention, the APIs for each device may be discovered by the customer premise gateway by entering a discovery mode to search for connected devices in cases where these devices are Internetworking protocol-enabled (e.g., IP-enabled smart devices that implement IP Internetworking protocols, or devices implementing CEBus internetworking protocols). Alternatively, a compact disk read only memory (CD-ROM) or diskette may be loaded onto a PC, wherein the portable medium (CD-ROM or diskette) would contain software that communicates with the customer premises gateway SDIP to load the smart device API specification onto the customer premise gateway SDIP. In further alternative embodiments, the software may be downloaded from the Internet, wherein after the download process is complete, the software downloaded will communicate with the customer premises gateway SDIP to load the smart device API specification onto the customer premises gateway SDIP. In still further alternative embodiments, smart devices may be discovered by prompting a user to enter information relating to the types of devices to be controlled directly into SDIP configuration pages, which are produced by the SDIP and served to the user through the Markup-Language-Type content server.

The above-described and other advantages are accomplished according to a CPG for providing access and control of one or more devices located at a customer premise, wherein the one or more devices are coupled to the CPG through one or more physical interfaces. The CPG includes one or more hardware drivers for driving the one more physical interfaces. Each hardware driver has a corresponding software driver which, in a number of cases, also implements a particular transport protocol.

In addition, the CPG contains one or more processors in communication with each other. The processors are programmed for configuring the hardware drivers using the software drivers to enable the transmitting and receiving of commands over the corresponding physical interface using a corresponding driver level protocol (Transport protocol). The processor(s) executing the SDIP, through the different functional areas of the SDIP, associates the smart device API with the appropriate Internetworking protocol (e.g., IP) and the appropriate Transport protocol (e.g., TCP) for that particular smart device to make the integration of those smart devices a seamless process for the CPG user. The processors may also query a particular device and retrieve API information from that device using the various internetworking protocols known to the SDIP and implemented on the CPG. The SDIP will then load the smart device API specification, and generate a Markup-Language-type page for the device in accordance with the API specification information for the device for displaying accessible or controllable parameters of the device through the Markup-Language-Type content server.

The CPG also includes memory for storing the API information corresponding to the one or more devices. A Markup-Language-type enabled (including XML enabled) Web browser couplable to the CPG through a broadband communication link, or a local computer couplable to the CPG through a physical interface, may be used for viewing the Markup-Language-type pages and controlling and monitoring the devices.

### BRIEF DESCRIPTION OF THE DRAWINGS

FIG. 1 is a block diagram illustrating a CPG and smart devices connected thereto according to a preferred embodiment of the present invention.

FIG. 2 is an exemplary initial access Markup-Language-type page including icons for smart device Markup-Language-type pages according to an embodiment of the present invention.

### DETAILED DESCRIPTION OF PREFERRED EMBODIMENTS

In the following description of preferred embodiments, reference is made to the accompanying drawings which form a part hereof, and in which is shown by way of illustration specific embodiments in which the invention may be practiced. It is to be understood that other embodiments may be utilized and structural changes may be made without departing from the scope of the preferred embodiments of the present invention.

Embodiments of the present invention generally disclose a system including a CPG which provides centralized Markup-Language-type enabled (including XML enabled) web browser access and control of smart devices, appliances and systems such as HVAC, lighting and security systems within the customer premise. The CPG may be used to access any smart device connected to any physical interface and using any communication protocol recognized by the system (CPG). The devices are hereinafter referred to as smart devices since they are configured for remote operation and control by a local computer on the customer premise through a Markup-Language-type enabled (including XML enabled) web browser, or by a remote computer through a Markup-Language-type enabled (including XML enabled) web browser, laptop, or hand-held computing device through a Markup-Language-type enabled (including XML enabled) web browser.

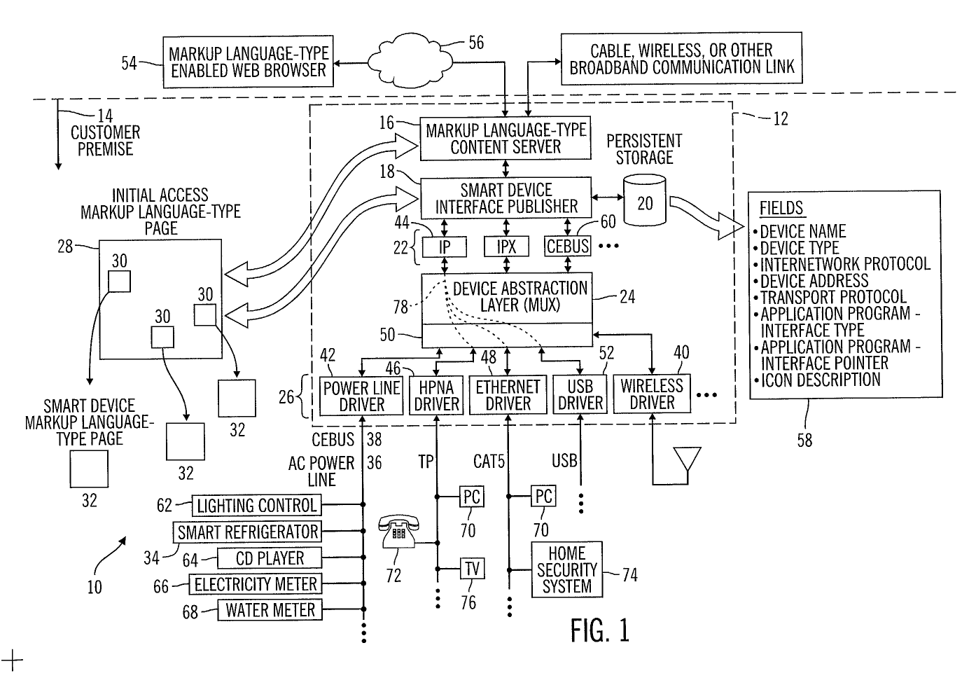

As illustrated in the system 10 of FIG. 1, a CPG 12 within a customer premise 14 includes a Markup-Language-type content server 16 (e.g. a Web server, which is an HTML content server, or an XML content server), a smart device interface publisher (SDIP) 18, which contains APIs generated as a result of loading smart device API specifications, persistent storage 20 (in the form of a flash RAM drive or a disk drive or the like), Internetworking protocols 22, a multiplexer (MUX) or software driver abstraction layer 24, and one or more physical interface and software drivers 26. It should be understood that the CPG 12 may contain one or more processors, busses, bus arbiters, and memory for performing functions distinguished by the functional blocks provided in FIG. 1. Thus, the CPG 12 may be a standalone device, a personal computer (PC) containing one or more circuit boards having interfaces to the different communication media, or a combination of both.

The SDIP 18 generates an initial access Markup-Language-type page 28 having icons 30 for the smart devices within the customer premise. This initial access Markup-Language-Type page is then served by a Markup-Language-Type content server (an HTTPD server or the like) to different users using a Markup-Language-Type enabled (including XML enabled) HTTP Web browser and, in response to navigation of the initial access Markup-Language-type page 28, the SDIP generates smart device Markup-Language-type (e.g., HTML or XML) pages 32 for accessing, monitoring, and controlling the smart devices. Each smart device Markup-Language-type page 32 may contain fields for accessible smart device parameters. For example, a smart refrigerator manufacturer may provide a specification for communicating with the smart refrigerator in the form of a smart refrigerator Markup-Language-type API specification (an XML page or the like). In alternative embodiments, a flat text file specification may be provided for specifying communication procedures with the smart refrigerator. The SDIP is responsible for loading the API specification file in its XML or flat text format and converting this API specification into a set of commands and references to perform different functions on the smart device (including setup, configuration, accounting and monitoring). The loading of the API specification file is performed by an SDIP API specification loading engine. The SDIP API specification loading engine receives the API specification, and makes it available to the different functions within the SDIP. The SDIP is thus able to store key parameters from the API specification into persistent storage to enable communications with the smart device.

The Markup-Language-type content server 16 can display the smart device Markup-Language-type page 32, which is produced by the SDIP 18 according to the loaded device API specification, to a user via a Markup-Language-type enabled (including XML enabled) Web browser 54 through a network 56 such as the Internet, an intranet, or a service provider network via broadband transmission media such as xDSL. As illustrated in FIG. 1, remote computers, laptops, and hand-held computing devices may also access the CPG 12 through cable communication links, wireless radio frequency (RF) communication links, satellite feeds, or other broadband communication links. In addition, the Markup-Language-type content server 16 can display the smart device Markup-Language-type page 32 to a local computer 70, acting as a viewer, for local control of smart devices. The local computer may communicate with the devices directly, or indirectly through the CPG 12, via the various physical interfaces shown in FIG. 1.

The SDIP 18 is the link that enables a user to access and control smart devices, appliances, and systems such as HVAC, lighting, and security systems within the customer premise using a Markup-Language-type enabled Web browser 54 without having to install special software at the user's computer, even though the smart devices may be connected to different physical interfaces and use different communication protocols. The SDIP 18 can be viewed as a application layer generic protocol, because it can take any API specification and convert it into an API.

The Markup-Language-type content server 16 communicates with the SDIP 18 when retrieving information from the persistent storage 20 or the smart devices. The SDIP may keep some smart device status, performance and other smart device attributes and activities in persistent storage 20. The SDIP 18 is responsible for querying the smart devices in the customer premise, retrieving information from those devices, and publishing it for the Markup-Language-type content server 16 in a Markup-Language-Type format (e.g., HTML or XML documents) that can be viewed using a Markup-Language-Type browser (e.g., HTML browsers or XML enabled browsers). However, for the SDIP 18 to perform its function of publishing content (retrieving information from the smart devices and sending it to the Markup-Language-type content server 16), the SDIP 18 must identify the interface that the device uses, and what communication protocols are being used.

For example, a smart refrigerator 34 may be connected to AC power wiring 36, may use the CEBus Transport protocol 38, may use the CEBus internetworking protocol 60, and may have an API specification that can be loaded by the SDIP 18 to build the API for the smart refrigerator. The SDIP 18 must encompass all this information in order to communicate with the smart refrigerator 34. When a user modifies the smart refrigerator Markup-Language-Type page in an attempt to control the smart refrigerator, the user is effectively communicating with the SDIP 18 through the Markup-Language-type content server 16. The SDIP 18 will perform specific functions according to the information from the API specification that it has loaded for the smart refrigerator. Thus, if the user enters a particular command from the smart refrigerator Markup-Language-Type page, the SDIP 18 will locate that command from a database of commands that the SDIP 18 has stored for the smart refrigerator. Once the command is located, the SDIP will send the command, including certain parameters, using a Internetworking protocol. If a response is received from the smart refrigerator, the response will be communicated back to the Markup-Language-type content server 16 and may be displayed on the smart refrigerator Markup-Language-Type page.

In alternative embodiments of the present invention, the SDIP 18 may be programmed through a smart device Markup-Language-Type page to perform particular commands on particular smart devices at particular times. Thus, the SDIP 18 may include a scheduling engine for this purpose.

The SDIP 18 maintains, for each smart device, information that includes, among other things, the full implementation of the API used to communicate with the smart device, the Internetworking protocol adopted by that smart device (e.g. CEBus, IP, or the like), the Transport protocol used (e.g. 802.11 or Bluetooth for a wireless driver 40, or the like), and the physical interface being used. Note that this is necessary because there may not be a one-to-one relationship between protocol layers. For example, as illustrated in FIG. 1, the Ethernet driver 48, the HPNA driver 46, and the Universal Serial Bus (USB) driver 52 may use the IP Internetworking protocol 44 (see dashed lines 78 in FIG. 1). In another example, in the future, the 802.11 Transport protocol may use the CEBus Internetworking protocol 60 to control smart devices. In such a situation, both the wireless driver 40 and a power line driver 42 would use the CEBus internetworking protocol 60.

The MUX 24 is an abstraction layer between the Internetworking protocols (e.g. IP, IPx, CEBus, and the like) and the Transport protocols and the lower layer physical interface software drivers 26. Previously, Internetworking protocols were written to interface directly with Transport protocols and software drivers. However, each time a new software driver was developed (e.g. USB software driver 52), it was necessary to write integration code to integrate the Internetworking protocol of choice with the new Transport protocol as part of that software driver. With the abstraction layer, a new software driver such as USB need only be written and tested against the USB physical interface (hardware). Once this is completed, the USB software driver with it's Transport protocol implementation can be interfaced to a standard MUX layer 24 which publishes a standard interface 50 to the Transport protocols of the software drivers.

The relationship between the standard interface 50 and a software driver is established when the software driver is added to the CPG 12. Every software driver must conform to the standard interface 50, and thus each software driver must register with the MUX 24 by publishing the API specification associated with the software driver to the MUX 24. In so doing, the software driver identifies pointers that the MUX 24 must call, according to its standard interface 50, in order to pass packets of data to the smart device. When the software driver is registered with the MUX 24, a corresponding identifier for the software driver is established, so that when a particular Internetworking protocol needs to communicate with the Transport protocol of a particular software driver 26, the Internetworking protocol provides the MUX 24 with an identifier corresponding to the Transport protocol of the particular software driver.

As FIG. 1 illustrates, any number of software drivers (and corresponding physical interface ports, although not shown in FIG. 1) may be included in the CPG 12. For example, FIG. 1 illustrates a power line software driver 42 (e.g. CEBus), an HPNA software driver 46, an Ethernet software driver 48, a USB software driver 52, and a wireless driver 40 (e.g. 802.11 or Bluetooth). The software drivers 26 implement Transport protocols and drive the actual physical interface, which is connected to a corresponding physical interface port. For example the CEBus physical interface port is coupled to the alternating current (AC) power wiring, the HPNA physical interface port is coupled to twisted pair telephone wiring, and the Ethernet physical interface port is coupled to Category 5 (CAT5) wiring. Although not shown in FIG. 1, other physical interfaces to smart devices may include, but are not limited to, coaxial cable, a fiber optic link, or a hybrid fiber optic/coaxial cable link. Those physical interfaces may have their own implementation of software drivers, Transport protocols and Internetworking protocols.

Smart devices couplable to the AC power wiring, twisted pair telephone wiring, CAT5 wiring, USB wiring, and the wireless link may include, but are not limited to, a lighting controller 62, a smart refrigerator 34, a digital CD, video, or versatile disc (DVD) player 64, an electricity meter 66, a water meter 68, personal computer (PC) 70, telephones 72, a home security system 74, and a television 76. Although not shown in FIG. 1, other smart appliances couplable to the AC power wiring, twisted pair telephone wiring, CAT5 wiring, USB wiring, and the wireless link may include, but are not limited to, automatically controlled drapes, HVAC systems, sprinkler systems, garage door openers, video and audio recorders, coffee makers and other cooking devices, and the like.

When a CPG 12 is first installed at a customer premise, a user may load an installation CD-ROM into a home PC 70, which allows the PC 70 to discover and reconfigure its internal network so that the PC 70 can access the Markup-Language-type content server 16 of the CPG 12.

The next step is to establish an interface between the CPG 12 and each of the smart devices. To establish the interface, the smart devices must be discovered. In preferred embodiments of the present invention, a discovery mode is initiated by the SDIP 18.

When the SDIP 18 is in a discovery mode, a discovery protocol such as the ARP (Address Resolution Protocol) for TCP/IP is applied to each physical interface defined using it's corresponding software driver, Transport protocol and Internetworking protocol, and all devices connected to the particular interface are discovered. The SDIP 18 will query the address discovered for the smart device on a specific management system port to upload the smart device API specification, complete the definitions associated with that smart device, and store the definitions into persistent storage. For example, in FIG. 1 the IP Internetworking protocol 44, which includes an ARP discovery protocol, will discover devices on the HPNA physical interface, the Ethernet physical interface, and the USB physical interface using the ARP discovery protocol, and will then send a smart device API specification discovery messages to a specific system port which may be, but is not limited to, port 4501, to which the device will respond with a line by line listing of its specifications. The API specifications, as described earlier, may be provided by the smart device in any Markup-Language-Type format such as HTML or XML. The SDIP 18 interprets the smart API device specifications and loads information from the API specifications into persistent storage. For example, a smart CD/cassette player API specification may look like the following:

Control Commands:

PlayCD: #

PlayTape: #

StopTape: #

StopCD: #

RecordTape: #

RecordTape: #

ChangeBass: #

ChangeVoulme: #

ChangeAmplification: #

ChangeBalance: #

Etc . . .

Status Commands:

CDStats

TapeStats

VolumeStats

BassStats

BalanceStats

AmplificationStats

If the API specification returned by the smart device has not been previously published, the SDIP 18 parses the API specification to extract smart device interface information and store it in persistent storage 20.

Thus, the persistent storage 20 maintains a list of smart devices (device name), the address of the smart device, the corresponding API (which is encompassed by the SDIP 18 and obtained by interpreting a smart device API specification), the Internetworking protocol used for that smart device, the Transport protocol used for that smart device, the software driver used, and the physical interface being used. As illustrated in FIG. 1, some of the fields 58 stored in the persistent storage 20 may include, but are not limited to: (1) device name (e.g., refrigerator), (2) device type (e.g., appliance, electronics, etc.), which further defines some behavioral patterns and parameters unique to that device type, (3) Internetwork protocol (e.g., IP), (4) device address (e.g., 1.2.20.4), (5) transport protocol (e.g. HPNA driver), (6) application program interface type (e.g., XML), (7) application program interface pointer (e.g., Data Structures), which is the pointer to the API itself, and (8) icon descriptor.

Once extracted and stored, the SDIP 18 presents the information to the Markup-Language-type content server 16 in the form of a smart device Markup-Language-type page 32. The Markup-Language-type content server 16 can then display the Markup-Language-type page 32 to a user via a Markup-Language-type enabled (including XML enabled) Web browser 54 through a network 56 such as the Internet. Note that after an API specification is initially parsed by the SDIP 18 and stored in persistent storage 20, whether it is in the form of a Markup-Language-type file or a flat text file, future communications with that smart device are enabled. In other words, once the API is received and parsed by the SDIP 18 the first time, the persistent storage 20 associated with the SDIP 18 saves the necessary information (reference character 58), so that subsequent retrieval of information from the smart device is easily handled directly through the SDIP 18.

If the API returned by the smart device has been previously published, the SDIP 18 reads the API and, if necessary, updates the appropriate fields in the persistent storage 20.

It should be understood that although the discovery process described above is preferred, in alternative embodiments, the API information can also be received by loading a CD-ROM or floppy disk containing that information, or downloading the information from any service provider, smart device manufacturer, or other source, and then using an API specification loading engine which instructs the SDIP 18 to load smart device API specifications from the CD-ROM running on the home PC 70 into the SDIP 18. In addition, the aforementioned loading software program may present a user interface containing prompts generated by the PC 70 for manually entering device information and communicating that information to the SDIP 18. Furthermore, the CPG 12 may also be programmed to communicate with the smart devices periodically to determine if an updated API is needed, and indicate the result in the smart device Markup-Language-type page 32.

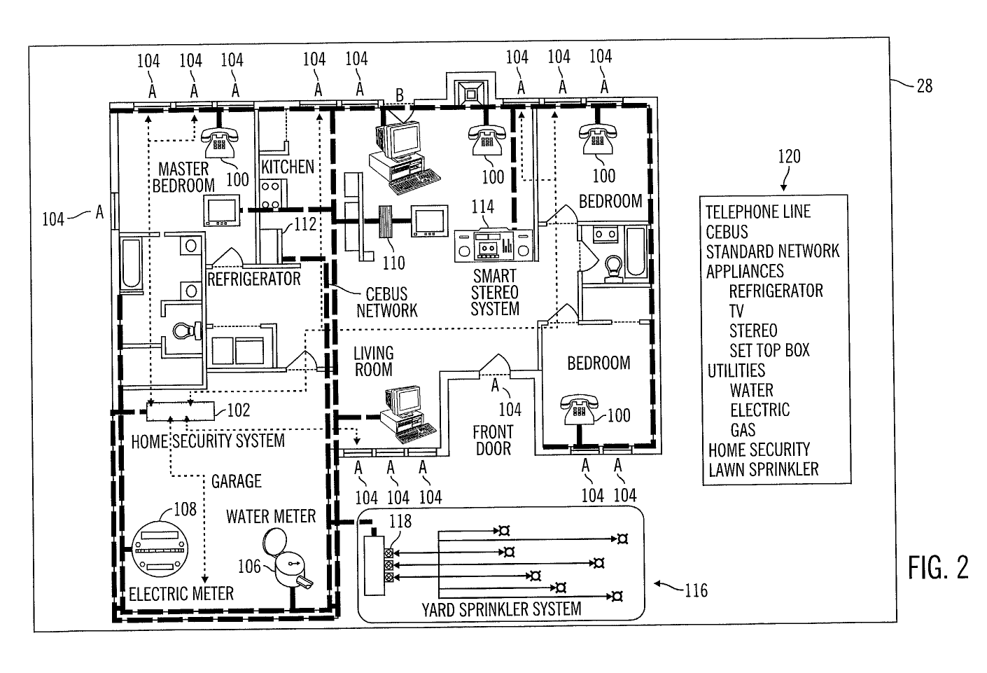

Once the smart device information has been discovered, the SDIP 18 can publish Markup-Language-type pages 28 and 30 to the Markup-Language-type content server 16 so that a user located remotely or at a PC within the premise, can access and control the smart devices. For example, as illustrated in FIG. 2, a user may first call up an initial access Markup-Language-type page 28, containing icons for smart device Markup-Language-type pages.

The first time the initial access Markup-Language-type page 28 is accessed, the CPG software program may generate a skeletal page containing icons for each smart device that has been discovered, or an ASCII list 120 of the smart devices. It should be understood that icon information may be discovered as part of the smart device API, or provided in the same CD-ROM that loads the smart device API specifications. The loading software program may then generate user prompts which may ask the user to enter information regarding the number of rooms in the customer premise. This information may then be uploaded into the SDIP 18 to enable the SDIP 18 to produce an initial access Markup-Language-Type page 28 with a background that can be made to resemble a generic residential or business floor plan. In alternative embodiments, a more sophisticated drawing program may be employed to allow a more accurate floor plan of the customer premise to be generated. The user may then be instructed to drag the icons to the appropriate location within the floor plan.

The exemplary initial access Markup-Language-type page 28 depicted in FIG. 2 includes an icon 100 representing each of a number of telephones, a home security system icon 102, security sensor icons 104, a water meter icon 106, a utility meter icon 108, a set top box icon 110, a smart refrigerator icon 112, a smart stereo system icon 114, a lawn sprinkler icon 116 including icons 118 for the different sprinkler valves, as well as graphic representations of the communication links (e.g., a HomePNA link, a CEBus network and a coaxial cable).

Once the initial access Markup-Language-type page 28 is defined, a user may click on one of the icons to access a smart device Markup-Language-type page 32. Each smart device Markup-Language-type page 32 provides an interface for a corresponding smart device based on its functions. The smart device Markup-Language-type page 32 may contain fields or prompts for various accessible or controllable parameters for that smart device, and may be used to input commands or otherwise control the device, or periodically get status from the device and send commands to the Markup-Language-type content server 16, which is then communicated to the device via the SDIP 18.

Referring again to FIG. 1, when the CPG 12 first boots up, core software in the CPG will be executed which will request that a particular Internetworking protocol such as IP 44 be connected to particular software drivers 26, which also implement Transport protocols. The IP Internetworking protocol 44 will then be registered with those software drivers 26 in the MUX 24 and given the appropriate priority for those interfaces. This mapping of Internetworking protocols to interfaces and Transport protocols is saved in persistent storage that is accessed by the CPG 12. Subsequently, if the MUX 24 receives IP packets destined for a smart device, it knows how to route the packets to the appropriate Transport protocol and the appropriate interface.

A summary of information flow from user to smart device and back will now be provided, using a smart refrigerator 34 as an example. When a user, working from the initial access Markup-Language-type page 28 (see FIG. 2), clicks on the icon of the smart refrigerator, the SDIP 18 retrieves, from persistent storage 20, a pointer to the appropriate smart refrigerator information stored in the fields 58 (see FIG. 1). The SDIP 18 then parses the information, creates a smart refrigerator Markup-Language-type page 32, and publishes it to the Markup-Language-type content server 16, which then makes it visible to the user. The user may then modify the smart refrigerator Markup-Language-type page and change certain values, such as the temperature setting.

The changed smart refrigerator Markup-Language-type page represents a device management message that must be communicated to the smart refrigerator. The information stored in the fields 58 instructs the SDIP 18 as to how to communicate with the smart refrigerator (e.g., the type of communication link, the selected protocol, the command and response set that is understood by the smart device, and the like). Furthermore, the SDIP 18 will determine the address for the smart refrigerator stored in it's persistent storage 20. In the present example, after reading all the device parameters, the SDIP 18 will determine that the CEBus Internetworking protocol 60 must be employed, and therefore the message will be communicated from the SDIP 18 to the abstraction layer 24 through the CEBus Internetworking protocol 60 on the smart refrigerator system control port specified in the smart refrigerator API specification (e.g. port 4501).

The SDIP 18 translates the smart refrigerator management message (e.g., data input via the smart refrigerator Markup-Language-type page 32), which may have arrived at the customer premise in HyperText Transport Protocol (HTTP) over Internet protocol (IP packets) or via a LAN, into a smart refrigerator device command for transmission over CEBus. Because the smart refrigerator address and system port number are stored in persistent storage 20, the SDIP 18 will use the smart refrigerator address and system port information to forward that command over the CEBus Internetworking protocol 60 through the MUX 24, then through the CEBus Transport protocol and software driver 26 to the refrigerator.

Continuing the present example for purposes of illustration only, the SDIP 18 can also receive and process status signals and other signals generated by the smart refrigerator, as there is an address and system port number associated with SDIP 18 for every Internetworking protocol that is known to the CPG 12 (i.e., the SDIP would have a set of IP addresses for the IP Internetworking protocol, which is the same as the IP addresses used by the CPG 12 for it's Ethernet IP identification and it's broadband (xDSL) IP address identification. However the SDIP would have a unique system port number for IP-type communications, through which other devices can talk directly to the SDIP 18). For example, if the smart refrigerator has reached a servicing interval, a smart refrigerator process may send a servicing message back to the SDIP 18, which will convert the message to a smart refrigerator Markup-Language-type page that will contain a servicing message, in order to notify the user, a service provider, or the smart refrigerator manufacturer, if they have access rights to the smart refrigerator Markup-Language-type page.

An integral part of the software functionality of the Markup-Language-type content server 16 is the ability to control service provider access to smart device Markup-Language-type pages 32. For maximum security, a general rule may be initially established that all access to smart device Markup-Language-type pages 32 is blocked except for the user. The user can then open access rights for specific service providers, based on certificates. For example, a CD-ROM from a service provider containing the API specification for a smart device may include a certificate. The Markup-Language-type content server 16 may be configured to check for that certificate. In alternative embodiments, a system of passwords may be established, each password allowing access to a particular smart device Markup-Language-type page 32.

Service providers having access to a smart device Markup-Language-type page 32 may be able to remotely control the smart device. For example, a security company may be able to monitor a premise security system and turn on or off various security devices. In addition, a manufacturer of the smart device may be able to automatically push new software upgrades to the smart device.

For purposes of illustration only, another example of user and service provider access will now be provided. A smart device Markup-Language-type page 32 for a smart refrigerator may allow the user to set the operating temperature and to enter or maintain information related to items stored in the refrigerator. For example, the smart refrigerator may include a bar code scanner for scanning in items that have been delivered (e.g., new packages), or need replacing (e.g., empty packages). Periodically, the smart refrigerator can be programmed via its API to send a message back to the SDIP 18, which may then send a message to a grocer's on-line delivery request system via the Internet 30 to automatically arrange for the delivery of an item when the bar code scanning inventory system indicates that the stock of an item has decreased below a selected level. Alternatively, the on-line grocer may be given access to the smart refrigerator Markup-Language-type page 32. The on-line grocer may then periodically access the page and arrange for the delivery of an item when the bar code scanning inventory system indicates that the stock of an item has decreased below a selected level. Furthermore, if the user becomes dissatisfied with a particular on-line grocer, the user could revoke the access rights of one online grocer, and grant access rights to another online grocer.

In preferred embodiments of the present invention, a user may select one or more PCs on the initial access Markup-Language-type page 28 to gain direct access to a particular computer and to perform various functions. Referring to FIG. 1, a remote user may schedule tasks with the Markup-Language-type content server 16 to make certain changes to a PC 70 within the premise. For example, each PC 70 may publish a network services API specification which enables a remote user, through the SDIP 18, to control the IP address of the PC or, more generally, the setup of the network stack in the PC. Each PC 70 may also publish a file access and management API specification, which would allow the copying, deleting, renaming, and the changing properties of files on the PC 70, in addition to enabling other aspects of file management. Each PC 70 may also publish a task monitoring and scheduling API specification to remotely monitor, start, or shut down tasks being performed on the PC 70. For example, a PC Markup-Language-type page may allow a user to monitor tasks being performed on the PC, and shutdown the task if the task is not authorized (e.g., a child playing an inappropriate game). Each PC 70 may also publish a system administration API specification for creating, deleting, and otherwise changing user access rights to the PC 70.

Therefore, embodiments of the present invention provide a device, system and method for centralized Markup-Language-type enabled (including XML enabled) web browser access and control of smart devices, appliances and systems such as HVAC, lighting and security systems on the customer premise. The system and method may be used to access any smart device connected to any physical interface using any communication protocol recognized by the system. Embodiments of the present invention also provide a device, system and method in which an initial access Markup-Language-type page is accessible from local or remote locations from which the user can establish network access using essentially any computer, laptop or hand-held computing device. In other words, the user is not limited to local or remote access to the smart devices via a particular computer on which a specific appliance automation program is installed.

In addition, embodiments of the present invention provide a device, system and method that can multiplex high bandwidth data into the customer premise over a plurality of communication media, including broadband communications. Accordingly, visibility of all devices controlled within the customer premise is available from the same point. Furthermore, because the present invention can receive broadband communications, there is sufficient bandwidth to handle multiple simultaneous accesses to the system.

What is claimed is:

1. A customer premises gateway (CPG) for providing access to, and control of, one or more smart devices located at a customer premise, the smart devices coupled to the CPG through one or more physical interfaces, the CPG comprising:
one or more hardware drivers, each hardware driver having a corresponding software driver, Transport protocol, and corresponding to a particular physical interface;
memory for storing Internetworking protocols and application programming interfaces (APIs) and API specification information corresponding to the smart devices; and
one or more processors in communication with each other and the hardware drivers, the processors programmed for
configuring the hardware drivers using the software drivers for transmitting and receiving messages over the corresponding physical interface using the Transport protocol associated with each software driver,
publishing a standard interface between the APIs, the Internetworking protocols, the Transport protocols, and the software drivers, and
in response to a message for a particular smart device,
selecting an API corresponding to the particular smart device,
querying the particular smart device and retrieving API specification information from the particular smart device in accordance with the selected API, and
generating a smart device page for the particular smart device for displaying accessible or controllable parameters of the particular smart device;
wherein a Markup-Language-type Web browser or a local computer is couplable to the CPG for viewing the smart device pages and controlling and monitoring the smart devices.

2. A CPG as recited in claim 1, wherein the Markup-Language-type Web browser is couplable to the CPG through a broadband communication link for viewing the smart device pages and controlling and monitoring the smart devices.

3. A CPG as recited in claim 1, wherein the local computer is couplable to the CPG through one or more of the physical interfaces for viewing the smart device pages and controlling and monitoring the smart devices.

4. A CPG as recited in claim 1, the processors further programmed for generating an initial access Markup-Language-type page viewable through the Markup-Language-type Web browser or the local computer and containing icons for accessing the smart device pages.

5. A CPG as recited in claim 1, wherein one or more of the smart device pages comprises a smart device Markup-Language-type page.

6. A CPG as recited in claim 2, each smart device page being configurable to enable one or more service providers to gain access to that smart device page through the through the broadband communication link for viewing the smart device page and controlling and monitoring the smart device.

7. A CPG as recited in claim 1, wherein the processors may be further programmed through the smart device page to send messages to particular smart devices at particular times.

8. A CPG as recited in claim 4, the processors further programmed for discovering the smart devices located at the customer premise by:
applying a discovery protocol corresponding to each Internetworking protocol for sending out a first discovery message over the physical interfaces;
receiving an acknowledgement message from each discovered smart device in response to the first discovery message;
requesting API specification information from each discovered smart device by sending out a second discovery message over the physical interface to which the discovered device is attached;
receiving the API specification information from each discovered smart device in response to the second discovery message;
parsing the API specification information to extract the smart device type, API, an address, and system port information for each discovered smart device over the Internetworking protocols associated with that device; and
storing the API specification information in the memory.

9. A CPG as recited in claim 8, the processors further programmed for converting the API specification information for each discovered smart device into a set of commands and references to perform different functions on the smart device, the functions including setup, configuration, accounting and monitoring.

10. A CPG as recited in claim 1, the processors further programmed for discovering the smart devices located at the customer premise by loading the API specification information for each smart device from a portable memory disk into the memory.

11. A CPG as recited in claim 2, the processors further programmed for discovering the smart devices located at the customer premise by downloading the API specification information using the broadband communication link into the memory.

12. A CPG as recited in claim 1, the processors further programmed for discovering the smart devices located at the customer premise by:
enabling a user to enter the API specification information using a user interface on the Markup-Language-type Web browser or the local computer; and
storing the API specification information in the memory.

13. A CPG as recited in claim 8, the processors further programmed for displaying an icon for each discovered smart device on the initial access Markup-Language-type page.

14. A CPG as recited in claim 1, the processors further programmed for receiving messages from the smart devices located at the customer premise by:
extracting API specification information from the received message using an appropriate API;
parsing the API specification information to extract message data; and
storing the message data in the memory.

15. A CPG as recited in claim 3, the processors further programmed for configuring the local computer couplable to the CPG through one or more of the physical interfaces by:
accessing the smart device page for the local computer; and
invoking a network services API specification to change the Internet Protocol (IP) address of the local computer, or invoking a file access and management API specification to copy, delete, rename, transfer, view, and change properties of files on the local computer, or invoking a task monitoring and scheduling API specification to remotely monitor, start, or shut down tasks that can performed on the local computer, or invoking a system administration API specification for creating, deleting, and otherwise changing user access rights to the local computer.

16. A system for providing access to, and control of, one or more smart devices located at a customer premise, comprising:
a plurality of smart devices;
a customer premises gateway (CPG) coupled to the smart devices through one or more physical interfaces, the CPG comprising
one or more hardware drivers, each hardware driver having a corresponding software driver, Transport protocol, and corresponding to a particular physical interface,
memory for storing Internetworking protocols and application programming interfaces (APIs) and API information corresponding to the smart devices, and
one or more processors in communication with each other and the hardware drivers, the processors programmed for
configuring the hardware drivers using the software drivers for transmitting and receiving messages over the corresponding physical interface using the Transport protocol associated with each software driver,
publishing a standard interface between the APIs, the Internetworking protocols, the Transport protocols, and the software drivers, and
in response to a message for a particular smart device,
selecting an API corresponding to the particular smart device,
querying the particular smart device and retrieving API specification information from the particular smart device in accordance with the selected API, and
generating a smart device page for the particular smart device for displaying accessible or controllable parameters of the particular smart device; and
a Markup-Language-type Web browser or a local computer coupled to the CPG for viewing the smart device pages and controlling and monitoring the smart devices.

17. A system as recited in claim 16, wherein the Markup-Language-type Web browser is coupled to the CPG through a broadband communication link for viewing the smart device pages and controlling and monitoring the smart devices.

18. A system as recited in claim 16, wherein the local computer is coupled to the CPG through one or more of the physical interfaces for viewing the smart device pages and controlling and monitoring the smart devices.

19. A system as recited in claim 16, the processors further programmed for generating an initial access Markup-Language-type page viewable through the Markup-Language-type Web browser or the local computer and containing icons for accessing the smart device pages.

20. A system as recited in claim 16, wherein one or more of the smart device pages comprises a smart device Markup-Language-type page.

21. A system as recited in claim 17, each smart device page being configurable to enable one or more service providers to gain access to that smart device page through the through the broadband communication link for viewing the smart device page and controlling and monitoring the smart device.

22. A system as recited in claim 16, wherein the processors may be further programmed through the smart device page to send messages to particular smart devices at particular times.

23. A system as recited in claim 19, the processors further programmed for discovering the smart devices located at the customer premise by:
applying a discovery protocol corresponding to each Internetworking protocol for sending out a first discovery message over the physical interfaces;
receiving an acknowledgement message from each discovered smart device in response to the first discovery message;
requesting API specification information from each discovered smart device by sending out a second discovery message over the physical interface to which the discovered device is attached;
receiving the API specification information from each discovered smart device in response to the second discovery message;
parsing the API specification information to extract the smart device type, API, an address, and system port information for each discovered smart device over the Internetworking protocols associated with that device; and
storing the API specification information in the memory.

24. A system as recited in claim 23, the processors further programmed for converting the API specification information for each discovered smart device into a set of commands and references to perform different functions on the smart device, the functions including setup, configuration, accounting and monitoring.

25. A system as recited in claim 16, the processors further programmed for discovering the smart devices located at the customer premise by loading the API specification information for each smart device from a portable memory disk into the memory.

26. A system as recited in claim 17, the processors further programmed for discovering the smart devices located at the customer premise by downloading the API specification information using the broadband communication link into the memory.

27. A system as recited in claim 16, the processors further programmed for discovering the smart devices located at the customer premise by:
enabling a user to enter the API specification information using a user interface on the Markup-Language-type Web browser or the local computer; and
storing the API specification information in the memory.

28. A system as recited in claim 23, the processors further programmed for displaying an icon for each discovered smart device on the initial access Markup-Language-type page.

29. A system as recited in claim 16, the processors further programmed for receiving messages from the smart devices located at the customer premise by:
extracting API specification information from the received message using an appropriate API;
parsing the API specification information to extract message data; and
storing the message data in the memory.

30. A system as recited in claim 18, the processors further programmed for configuring the local computer couplable to the CPG through one or more of the physical interfaces by:
accessing the smart device page for the local computer; and
invoking a network services API specification to change the Internet Protocol (IP) address of the local computer, or invoking a file access and management API specification to copy, delete, rename, transfer, view, and change properties of files on the local computer, or invoking a task monitoring and scheduling API specification to remotely monitor, start, or shut down tasks that can performed on the local computer, or invoking a system administration API specification for creating, deleting, and otherwise changing user access rights to the local computer.

31. A method for providing access to, and control of, one or more smart devices coupled to one or more physical interfaces and located at a customer premise, the method comprising the steps of:
storing Internetworking protocols and application programming interfaces (APIs) and API specification information corresponding to the smart devices;
transmitting and receiving messages over the physical interfaces using Transport protocols and software drivers associated with each physical interface;
publishing a standard interface between the APIs, the Internetworking protocols, the Transport protocols, and the software drivers;
in response to a message for a particular smart device,
selecting an API corresponding to the particular smart device,
querying the particular smart device and retrieving API specification information from the particular smart device in accordance with the selected API, and
generating a smart device page for the particular smart device for displaying accessible or controllable parameters of the particular smart device; and
controlling and monitoring the smart devices using the smart device pages viewable through a Markup-Language-type Web browser or a local computer.

32. A method as recited in claim 31, further including the step of controlling and monitoring the smart devices using the smart device pages viewable through a broadband communication link.

33. A method as recited in claim 31, further including the step of controlling and monitoring the smart devices using the smart device pages viewable through the local computer.

34. A method as recited in claim 31, further including the step of generating an initial access Markup-Language-type page viewable through the Markup-Language-type Web browser or the local computer and containing icons for accessing the smart device pages.

35. A method as recited in claim 31, the step of generating a smart device page comprising generating a smart device Markup-Language-type page.

36. A method as recited in claim 32, further including the step of configuring one or more smart device pages to enable one or more service providers to gain access to those smart device pages through the through the broadband communication link for viewing the smart device page and controlling and monitoring the smart device.

37. A method as recited in claim 31, further including the step of inputting commands via the smart device page to send messages to particular smart devices at particular times.

38. A method as recited in claim 34, further including the step of discovering the smart devices located at the customer premise by:
applying a discovery protocol corresponding to each Internetworking protocol for sending out a first discovery message over the physical interfaces;
receiving an acknowledgement message from each discovered smart device in response to the first discovery message;
requesting API specification information from each discovered smart device by sending out a second discovery message over the physical interface to which the discovered device is attached;
receiving the API specification information from each discovered smart device in response to the second discovery message;
parsing the API specification information to extract the smart device type, API, an address, and system port information for each discovered smart device over the Internetworking protocols associated with that device; and
storing the API specification information.

39. A method as recited in claim 38, further including the step of converting the API specification information for each discovered smart device into a set of commands and references to perform different functions on the smart device, the functions including setup, configuration, accounting and monitoring.

40. A method as recited in claim 31, further including the step of discovering the smart devices located at the customer premise by receiving the API specification information for each smart device from a portable memory disk.

41. A method as recited in claim 32, further including the step of discovering the smart devices located at the customer premise by downloading the API specification information using the broadband communication link.

42. A method as recited in claim 31, further including the step of discovering the smart devices located at the customer premise by:
enabling a user to enter the API specification information using a user interface on the Markup-Language-type Web browser or the local computer; and
storing the API specification information.

43. A method as recited in claim 38, further including the step of displaying an icon for each discovered smart device on the initial access Markup-Language-type page.

44. A method as recited in claim 31, further including the step of receiving messages from the smart devices located at the customer premise by:
extracting API specification information from the received message using an appropriate API;
parsing the API specification information to extract message data; and
storing the message data.

45. A method as recited in claim 33, further including the step of configuring the local computer by:
accessing the smart device page for the local computer; and
invoking a network services API specification to change the Internet Protocol (IP) address of the local computer, or invoking a file access and management API specification to copy, delete, rename, transfer, view, and change properties of files on the local computer, or invoking a task monitoring and scheduling API specification to remotely monitor, start, or shut down tasks that can performed on the local computer, or invoking a system administration API specification for creating, deleting, and otherwise changing user access rights to the local computer.
